(19) United States
(12) Patent Application Publication
(10) Pub. No.: US 2018/0339341 A1
(43) Pub. Date: Nov. 29, 2018

(54) METHOD FOR ADDITIVE MANUFACTURING USING ELECTRON BEAM MELTING WITH STAINLESS STEEL 316L

(71) Applicant: HTL Co. Japan Ltd., Tokyo (JP)

(72) Inventors: Ryuji Tatsumi, Tokyo (JP); Achintya Acharya, Tokyo (JP); Kazunari Egami, Tokyo (JP)

(73) Assignee: HTL Co. Japan Ltd., Tokyo (JP)

(21) Appl. No.: 15/987,918

(22) Filed: May 24, 2018

(30) Foreign Application Priority Data
May 24, 2017 (JP) 2017-102599

(51) Int. Cl. B22F 3/105; B23K 15/00; B23K 15/06

(52) U.S. Cl. CPC B22F 3/1055; B23K 15/0086; B23K 2103/05; B22F 2003/1057; B22F 2301/35; B23K 15/06

(57) ABSTRACT

Before performing additive manufacturing of an article to be formed, a first scale plate is scanned in a first scanning speed so that a trace of the electron beam is depicted. An electric current value through a focusing coil with which the trace of the electron beam becomes narrowest is found and set as a melting electric current value. Then, a second scale plate is scanned similarly in the first scanning speed so that a trace of the electron beam is depicted. An electric current value through the focusing coil with which the trace of the electron beam cannot be seen is found and set as a preheating focusing electric current value. Dispersed metal powder is scanned with electron beam of the preheating electric current value as set before in a second scanning speed 20 to 30 times of the first scanning speed. Thereafter, the additive manufacturing is performed.

### CROSS REFERENCE TO RELATED APPLICATIONS

This application claims the priority benefit of Japanese Patent Application No. 2017-102599, filed on May 24, 2017. The entirety of the above-mentioned patent application is hereby incorporated by reference herein and made a part of this specification.

### TECHNICAL FIELD

The present disclosure relates to a method for additive manufacturing using electron beam melting with stainless steel SUS316L.

### BACKGROUND ART

Methods for additive manufacturing (referred to as “AM methods” below) are basked in the limelight recently. As one of these AM methods, there is a powder bed method in which powder of macromolecular compound or metal dispersed uniformly on a flat plate (referred to as “start plate” below) to form a layer is sintered or molten to be solidified with high energy beam such as laser beam or electron beam, and then similar operations are repeated with the powder dispersed again.

In this powder bed method, high energy beam irradiated on powder to be scanned according to data of figures desired for additive manufacturing so that powder is solidified to yield manufactured articles.

Here, much remark is made on electron beam having high efficiency as a source of high energy. Process of heating and melting by such electron beam is performed through converting kinetic energy of electrons (particles) accelerated to velocity near to that of light and having rest mass of about 9×10⁻³¹ Kg into thermal energy and about 80% of kinetic energy is considered to be used as thermal energy.

In an additive manufacturing using electron beam melting (referred to as “EBM”) in which, with such powder bed method, a three-dimensional structure is manufactured through laminating layers in which metal powder is selectively molten-solidified using electron beam as an energy source, wherein the phenomena called as “smoke” may occur when metal powder in a room temperature is molten for melting metal powder to perform additive manufacturing, thus not securing stable additive manufacturing.

As such, metal powder as a whole is heated preliminarily to a high temperature to be in a preliminarily sintered state in an additive manufacturing method using EBM, thereafter, additive manufacturing is performed according to data.

In this, while electron beam is used as a heat source for preliminarily heating the metal powder as a whole to be in a provisionally sintered state, it is important to restrain density of electron beam in a suitable level. This is because, when density of electron beam is in a high level, metal powder becomes molten or has high strength due to provisional sintering, so that it becomes difficult to take out manufactured articles.

In order to solve such problems with a three-dimensional additive manufacturing using EBM, a thermometer is placed on the back face of a start plate, then electron beam is irradiated for scanning on the start plate at first to heat it to a determined temperature. Then, metal powder is dispersed on the start plate and electron beam is irradiated for scanning on the dispersed metal powder as a whole to heat the metal powder. After then, contour of a shape is continuously molten so that internal portion of a structure is molten according to data. Three-dimensional additive manufacturing can be attained by repeating this process.

In strategy of manufacturers of additive manufacturing apparatus using EBM with additive manufacturing method using EBM, software for additive manufacturing is developed putting emphasis on titanium alloys, titanium-aluminum alloys (see Patent Document 1) or nickel alloys used in aerospace industry or medical industry. As a result, mechanical strength is far beyond that of castings and near to that of forgings (see Non-patent Document 1), so products by additive manufacturing are employed for blades of a jet plane engine or artificial bones. On the other hand, only passive development of software for additive manufacturing was made for stainless steel or metals for tools that have been much required in this country. Due to this, it is eagerly desired to apply additive manufacturing method using EBM to these materials.

With an additive manufacturing method using EBM, additive manufacturing is performed using an apparatus composed as shown in FIG. 1 generally through steps as follows.

Scanning is made with electron beam 7 made of electrons generated in a filament 1 and accelerated with a grid 2 and an anode 3 after shaping and converging with an astigmatism correcting coil 4, a focusing coil 5 and deflecting coil 6 to be irradiated on metal powder dispersed on a start plate 13 disposed on an elevator 9.

A temperature sensor 14 is disposed on the back face of the start plate 13, so that temperature of the start plate 13 raised by irradiation of electron beam 7 can be measured with the temperature sensor 14. Metal powder 12 supplied from a powder container 10 can be smoothed to be flat with a rake 11 so as to have a uniform thickness.

These steps are performed in a vacuum chamber 8.

Additive manufacturing begins with heating of the start plate 13. Temperature of the start plate 13 is monitored with the temperature sensor 14 and scanning with electron beam continues until a determined temperature is attained.

When temperature has attained a determined one, metal powder 12 is caused to flow out of the powder container 10, the metal powder is dispersed evenly on the start plate 13 causing the rake 11 to move through and electron beam is irradiated for scanning in a preheating mode. After preheating the entire area of the metal powder has been completed, irradiation with convergence in a melting mode is performed to form a shape to be molten according to data.

Here, electron density of irradiated electron beam is set to have a required value for each of the preheating mode and the melting mode. Further, it is important to control total dose of supplied electron beam, that is, total electric power according to the shape or material of an article to be formed. Such total energy to be supplied in an additive manufacturing apparatus using EBM is taken to be 3 kw.

For example, in a case where electron beam of 20 mA (corresponding to 1.2 kW) is irradiated, total number of irradiated electrons is about 1.248316596×10¹⁸/sec). Strength distribution of irradiated electron beam is basically a normal probability distribution as shown in FIG. 2, in which the vertical axis denotes electron density.

Supposing that electron beam converges in a width of 300 microns of 3σ, number of electrons irradiated in a center area having a width of 100 microns is 4.9907697×10¹⁶/sec and number of electrons irradiated in a center area having a width of 100 microns of 3σ is 1.123484×10¹⁵.

As explained above, electron beam converging in a width of about 300 microns of 3σ is one having a sufficiently high electron density also in the peripheral area.

Patent Document 1:

Non-patent Document 1:

Ackelid, U and Svensson, M: Additive manufacturing of Dense Metal Parts by Electron Beam Melting, Materials Science and Technology, pp.2711-2719 (2009)

### SUMMARY

In additive manufacturing with stainless steel SUS316L by use of such an additive manufacturing apparatus using EBM, allowable temperature range for stable process is narrow due to higher thermal conductivity compared with titanium alloy, so that failure occurs often in setting heating mode and melting mode and strain in additive manufacturing or residual strain also occurs often.

Further, in a case where too much total electron beam is supplied, strain occurs in a manufactured article and preliminary sintering is strengthened, and the release of it becomes difficult. Furthermore, even if the total electron beam is supplied in a suitable amount, release becomes difficult when electron density in preliminary sintering is too high.

Moreover, in a case where total electron beam is supplied to a less extent, smoke phenomena, in which metal powder is scattered in melting due to lack of preliminary sintering, may occur to cause the apparatus to stop operation, or lack of melting may occur due to low temperature at the site of melting.

The present disclosure provides the following embodiments. Here, reference signs used in the following explanation of embodiments and figures are added for convenience but composing elements of the disclosure are not limited by ones with such reference signs added.

Referring FIG. 3, a first embodiment according to the disclosure is a method for additive manufacturing using electron beam melting with stainless steel SUS316L executed by use of an additive manufacturing apparatus using electron beam melting, in which electron beam 7 is used as an energy source and which is equipped with an electron optical system comprising a astigmatism correcting coil 4, a focusing coil 5 and deflecting coil 6 that makes scanning with and converges the electron beam in two-dimensions according to additive manufacturing data prepared by laying out three-dimensional CAD data of at least one article to be formed through additive manufacturing, and a start plate 13 having a temperature sensor 14 held on a back face thereof, and the start plate 13 is disposed on an upper face of a raising and lowering mechanism (an elevator 9), that is also a face on which the electron beam is converged,

said method being executed, after dispersing metal powder 12 on the start plate heated preliminarily and smoothing the metal powder with a rake 11 to be flat, through scanning with the electron beam in two dimensions to melt the metal powder and forming a layer for each step and performing additive manufacturing of the article to be formed by laminating layers in successive steps by lowering the raising and lowering mechanism,

wherein said method further comprises:

using stainless steel 316L as the metal powder,

before performing the additive manufacturing of the article to be formed, placing a first scale plate 15 on the start plate, scanning the first scale plate with the electron beam in a first scanning speed set to be 500 mm/sec to 650 mm/sec while varying the converged point by varying electric current value through the focusing coil so that a trace of the electron beam is depicted on the first scale plate, taking out the first scale plate, and setting a melting electric current value for melting the metal powder from an electric current value through the focusing coil found to be one with which the trace of the electron beam becomes narrowest,

placing a second scale plate on the start plate, scanning the second scale plate with the electron beam in the first scanning speed while varying the converged point by varying electric current value through the focusing coil around the melting electric current value so that a trace of the electron beam is depicted on the second scale plate, taking out the second scale plate, and setting a preheating focusing electric current value for preheating the metal powder from an electric current value through the focusing coil found to be one with which the trace of the electron beam cannot be seen, and

performing additive manufacturing after preheating the metal powder of stainless steel SUS316L dispersed on the start plate and smoothed with a rake to be flat by scanning the metal powder with the electron beam having the set preheating focusing electric current value in a second scanning speed of 20 to 30 times of the first scanning speed.

In the method for additive manufacturing using electron beam melting with stainless steel SUS316L according to a second embodiment of the disclosure, a material of the first scale plate and the second scale plate is the stainless steel SUS316L in the first embodiment.

In the method for additive manufacturing using electron beam melting with stainless steel SUS316L according to a third embodiment of the disclosure, the additive manufacturing is performed when the temperature detected with the temperature sensor is 875° C. to 925° C. in the first or second embodiment.

With the method for additive manufacturing using electron beam melting of SUS316L according to the first embodiment, in three-dimensional additive manufacturing with metal powder of SUS316L, scanning a first scale plate with electron beam while varying electric current value through a focusing coil so that a trace of the electron beam is depicted on the first scale plate, a smallest converged point and an electric current value through the focusing coil at this time is obtained through observing the result. Then subsequently, scanning a second scale plate with electron beam in a similar manner of operation with preheating electric current, electric current through the focusing coil, with which trace of electron beam is not found, is obtained and the value is set as electric current at the time of preheating. Further, scanning speed for preheating metal powder is set to be between 20 times and 30 times of one for scanning the scale plates mentioned above.

With this manner of setting, strain is not generated in an article to be formed and release of metal powder in sites of preliminary sintering becomes easy.

With the method for additive manufacturing using electron beam melting of SUS316L according to the second embodiment, SUS316L is used for the scale plate and the material is identical with the material of metal powder, so that action effect of electron beam on the scale plate becomes approximated to that of metal powder, hence range of current to be set through the focusing coil for preheating can be narrowed.

With the method for additive manufacturing using electron beam melting of SUS316L according to the third embodiment, residual strain during and after additive manufacturing can be minimized and an article of SUS316L having excellent quality can be formed.

According to the present disclosure, an article to be formed can be obtained with which strain in additive manufacturing is minimized and release of metal powder in preliminary sintering becomes easy. Thus, conspicuous advantageous effect is brought by the disclosure.

### BRIEF DESCRIPTION OF THE DRAWINGS

FIG.1 is a schematic view showing a composition inside of a vacuum chamber in a method for additive manufacturing using EBM.

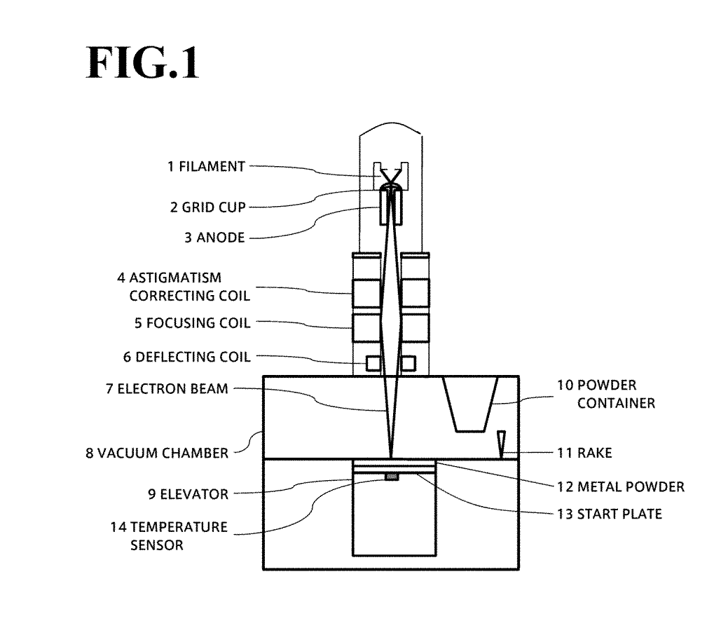

FIG.2 is a graph showing a strength distribution of electron beam.

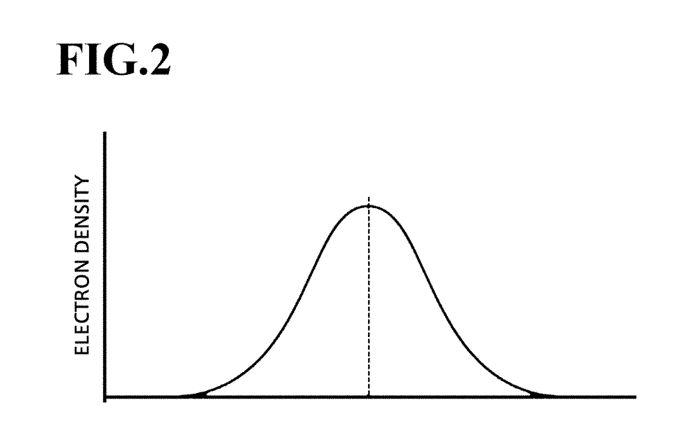

FIG.3 is an explanatory view of disposing a scale plate used in the method for additive manufacturing using EBM according to the present disclosure.

FIG. 4 is a view showing an example of a scale plate used in the present disclosure.

### DESCRIPTION OF THE EMBODIMENTS

The present disclosure provides a method for three-dimensional additive manufacturing using electron beam melting with SUS316L executed by use of an additive manufacturing apparatus using electron beam melting, in which electron beam is used as an energy source and which is equipped with an electron optical system comprising an astigmatism correcting coil, a focusing coil and deflecting coil that makes scanning with and converges the electron beam in two dimensions according to additive manufacturing data prepared by laying out three-dimensional CAD data of at least one article to be formed through additive manufacturing, and a start plate having a temperature sensor held on a back face thereof, wherein the start plate is disposed on an upper face of an elevator that is also a face on which the electron beam is converged,

said method being executed, after dispersing metal powder on the start plate heated preliminarily and smoothing the metal powder with a rake to be flat, through scanning with electron beam in two dimensions to perform heating and preliminary sintering of the metal powder, thereafter irradiating electron beam on and melting the metal powder in necessary sites thereof according to data to form a layer for each step and successively performing additive manufacturing of the article to be formed by repeating each step of forming a layer while lowering the elevator and dispersing metal powder on the layer formed in the previous step,

wherein said method further comprises:

before performing the additive manufacturing of the article to be formed, placing a scale plate on the start plate, scanning the scale plate with electron beam in a scanning speed set to be 500 mm/sec to 650 mm/sec while varying the converged point by varying electric current value through the focusing coil so that a trace of the electron beam is depicted on the scale plate, taking out the scale plate, and setting a converging electric current value for melting the metal powder from an electric current value through the focusing coil found to be one with which the trace of the electron beam becomes narrowest,

raising output of electron beam to set preheating focusing electric current value, varying electric current value through the focusing coil around the melting-converging electric current value so that a trace of the electron beam is depicted in the aforementioned scanning speed, taking out the depicted trace to be observed and setting an electric current value through the focusing coil found to be one with which the trace of the electron beam cannot be observed as electric current through focusing coil at the time of preheating,

preheating dispersed metal powder in a scanning speed set to be 20 to 30 times of the aforementioned scanning speed, and

performing additive manufacturing with stainless steel SUS316L.

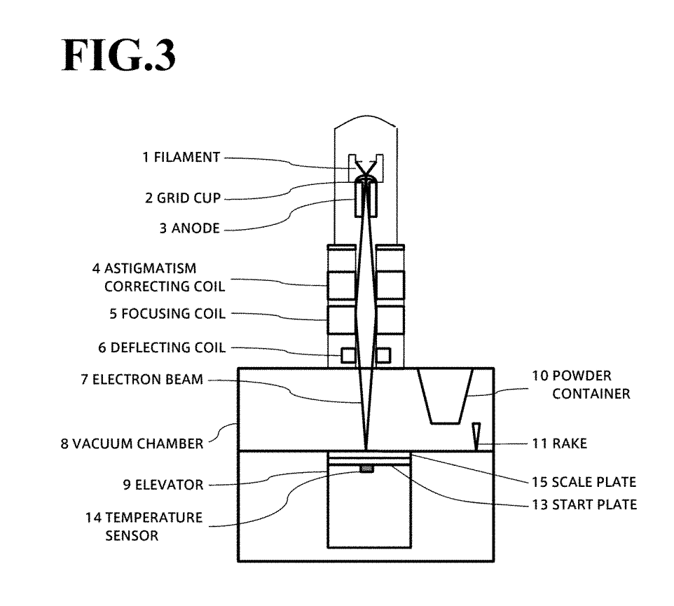

Embodiments of the present disclosure will be explained in detail, referring to figures. FIG. 3 is an explanatory view showing a composition inside of a vacuum chamber in which a scale plate is disposed in a method for additive manufacturing using EBM. When electric current is fed from an electric circuit (not shown) to heat a filament 1, electrons are generated.

The electrons are accelerated via a grid cup 2 and an anode 3, to which a high voltage is applied from a high voltage power source (not shown), and emitted through an opening of the anode to be electron beam 7. At this time, the electrons are accelerated to have about a half of velocity of light.

The electron beam is converged for scanning with a magnetic lens consisting of an astigmatism correcting coil 4, a focusing coil 5 and a deflecting coil 6 and is converged onto a scale plate 15 placed on a start plate 12 disposed on an elevator 9. The scale plate has a purpose of measuring a diameter of electron beam and optimizing it. For this sake, a suitable plate size is selected by taking it into consideration to remove effect of warping due to heat and besides to measure change in diameter due to focusing variation explained below, etc.

In an example, a plate size of “240 mm (vertical)×240 mm (horizontal)×5 mm (thickness)” is selected.

In such a condition, a trace by scanning is depicted with current value through the filament, current value through the deflecting coil determining scanning velocity and current value through the focusing coil controlling a convergent point as parameters. At this time, scanning is performed with an initial setting for measuring the diameter of electron beam such that scanning speed is 500 mm/sec to 650 mm/sec and electric current value through the filament is 10 mA to 25 mA.

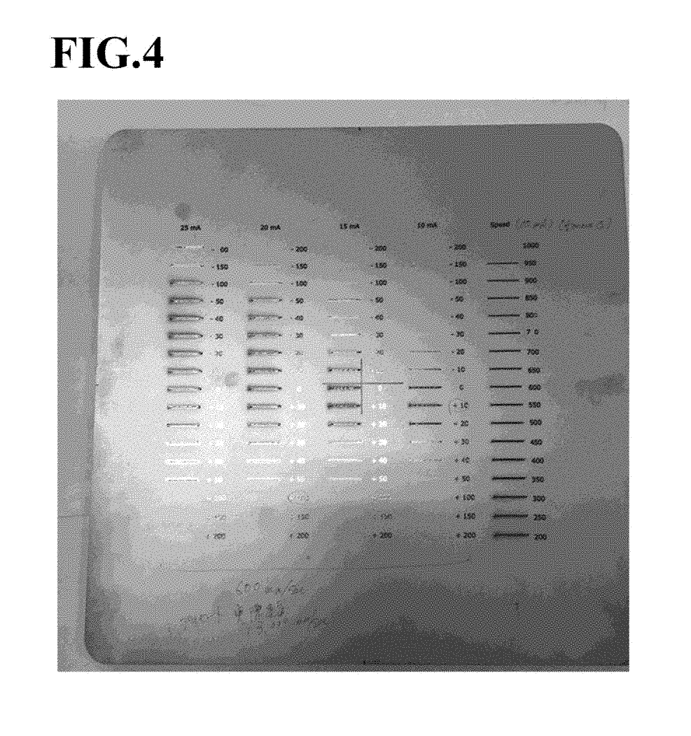

FIG. 4 is a photograph showing an example of a scale plate in which scales are marked on a stainless steel plate. In FIG. 4, setting is made in such a manner that electric current at the time of melting is 10 mA, electric current at the time of preheating is 20 mA, offset of electric current through the focusing coil at the time of melting is +10 mA and offset of electric current through the focusing coil at the time of preheating is +100 mA. With the offset value being large, electron beam becomes defocused. Best focusing is selected at the time of melting to make adequate melting and defocusing is selected at the time of preheating to cause powder not to be in a too solidified state. It is recommended to make measurement using a tool microscope for observation of electron beam traces in the scale plate shown in FIG. 4.

Here, it is preferable that material of the scale plate is the aforementioned SUS316L. The reason for this is that, by use of SUS316L for the scale plate, action effect of electron beam on the scale plate becomes approximated to that of metal powder because material of the scale plate is identical with that of metal powder, hence range of current to be set through the focusing coil for preheating can be narrowed.

Further, it is preferable that additive manufacturing is performed when temperature detected with the temperature sensor is 875° C. to 925° C. It was recognized from experiments that sintering is insufficient at 850° C. and residual strain remains at 950° C., thus temperature of 875° C. to 925° C. is suitable.

Additionally, a trademark “HTLebmMTL” according to a trademark application 2017-14021 is intended to be used for the metal powder of the stainless steel SUS316L employed in the present disclosure.

The stainless steel SUS316L for example, comprises carbon (C): ≤0.03 mass %; silicon (Si); ≤1.00 mass %; manganese (Mn); ≤2.00 mass %; phosphorous (P): ≤0.045 mass %; sulfur (S): ≤0.030 mass %; chromium (Cr); 16.00-18.00 mass %; molybdenum (Mo): 2.00-3.00 mass %; nickel (Ni); 12.00-15.00 mass %, and the balance being iron.

What is claimed is:

1. A method for additive manufacturing using electron beam melting with SUS316L executed by use of an additive manufacturing apparatus using electron beam melting, in which electron beam is used as an energy source and which is equipped with an electron optical system comprising a astigmatism correcting coil, a focusing coil and deflecting coil that makes scanning with and converges the electron beam in two-dimensions according to additive manufacturing data prepared by laying out three-dimensional CAD data of at least one article to be formed through additive manufacturing, and a start plate having a temperature sensor held on a back face thereof and the start plate is disposed on an upper face of a raising and lowering mechanism, that is also a face on which the electron beam is converged,
said method being executed, after dispersing metal powder on the start plate heated preliminarily and smoothing the metal powder with a rake to be flat, through scanning with the electron beam in two dimensions to melt the metal powder and forming a layer for each step and performing additive manufacturing of the article to be formed by laminating layers in successive steps by lowering the raising and lowering mechanism, wherein said method further comprises:
using stainless steel SUS316L as the metal powder,
before performing the additive manufacturing of the article to be formed, placing a first scale plate on the start plate, scanning the first scale plate with the electron beam in a first scanning speed set to be 500 mm/sec to 650 mm/sec while varying the converged point by varying electric current value through the focusing coil so that a trace of the electron beam is depicted on the first scale plate, taking out the first scale plate, and setting a melting electric current value for melting the metal powder from an electric current value through the focusing coil found to be one with which the trace of the electron beam becomes narrowest,
placing a second scale plate on the start plate, scanning the second scale plate with the electron beam in the first scanning speed while varying the converged point by varying electric current value through the focusing coil around the melting electric current value so that a trace of the electron beam is depicted on the second scale plate, taking out the second scale plate, and setting a preheating focusing electric current value for preheating the metal powder from an electric current value through the focusing coil found to be one with which the trace of the electron beam cannot be seen, and
performing additive manufacturing after preheating the metal powder of stainless steel SUS316L dispersed on the start plate and smoothed with a rake to be flat by scanning the metal powder with the electron beam having the set preheating focusing electric current value in a second scanning speed of 20 to 30 times of the first scanning speed.

2. The method for additive manufacturing using electron beam melting with SUS316L according to claim 1,
wherein a material of the first scale plate and the second scale plate is stainless steel SUS316L.

3. The method for additive manufacturing using electron beam melting with SUS316L according to claim 1,
wherein the additive manufacturing is performed when the temperature detected with the temperature sensor is 875° C. to 925° C.

4. The method for additive manufacturing using electron beam melting with SUS316L according to claim 2,
wherein the additive manufacturing is performed when the temperature detected with the temperature sensor is 875° C. to 925° C.
